(19) United States
(12) Patent Application Publication
(10) Pub. No.: US 2018/0079656 A1
(43) Pub. Date: Mar. 22, 2018

(54) Method and device for the hydrolysis of liquid, organic substrates

(71) Applicant: Andreas Dünnebeil, Teltow (DE)

(72) Inventor: Andreas Dünnebeil, Teltow (DE)

(21) Appl. No.: 15/698,449

(22) Filed: Sep. 7, 2017

(30) Foreign Application Priority Data
Sep. 20, 2016 (DE) 10 2016 217 960.8

(51) Int. Cl. C02F 1/02; C02F 11/18; B01J 4/00; B01J 8/08; B01J 8/18; B01J 19/00

(52) U.S. Cl. CPC C02F 1/025; C02F 11/18; B01J 4/001; B01J 8/087; B01J 8/1854; B01J 2204/007; B01J 19/0086; C02F 2305/14; C02F 2301/046; C02F 2209/001; C02F 2209/06; B01J 19/0053

(57) ABSTRACT

In a method for the hydrolysis of liquid, organic substrates (1), the substrate to be hydrolysed is introduced into a circulation loop for heating, where an equal amount of hydrolysed substrate (1) is displaced from the circulation loop (6, 7, 8, 9). An appropriate system can have a circulation loop, a feed device, a circulation pump for generating a circulation flow in the circulation loop, and a heater for heating and reheating the circulation flow.

This United States utility patent application claims priority on and the benefit of German (DE) patent application number 10 2016 217 960.8, filed Sep. 20, 2016, the entire contents of which are hereby incorporated herein by reference.

### BACKGROUND OF THE INVENTION

### 1. Field of the Invention

The invention relates to a method and a device for the hydrolysis of liquid, organic substrates or in liquid, organic substrates, in particular with the assistance of the application of heat and, if required, with the addition of caustic solution.

The terms disintegration, decomposition, cell decomposition and hydrolysis are used in the field of this technical application and all describe a destruction of the organic cell structures with a release of the constituents and, in many applications, their at least partial chemical conversion. For this reason, only the term hydrolysis is used representatively below.

Organic substances, for example effluent sludge, frequently contain a large quantity of reusable materials and energy. Reusable materials in the form of fertilizers are obtained on an industrial scale from effluent sludge, for example, as a crystalline compound in the form of struvite, using the Airprex method. Various other methods are used to make the energy contained in the organic compound available. This relates to organic sludges such as occur in sewage plants, and also sludges of organic substances which are, for example, converted and used to produce energy in biogas plants. One approach here is to make the organically bonded substances available for microorganisms of an anaerobic biogas production plant. These methods are being increasingly used in the field of effluent sludge treatment. As well as the enhanced energy yield due to the increased biogas production, the possibility of recovering nutrients such as phosphorus and nitrogen also plays a role.

The main application in sewage plants is the concentrated surplus sludge. Large quantities of organic compounds within the microorganisms are incorporated in this sludge due to the cell membranes. This organic substrate can often not be accessed due to the anaerobic microorganisms in the production of anaerobic methane gas, such as in digestion or biogas plants, as the cell membranes provide insurmountable protection for these. This can also have the effect, for example, that the originally aerobic microorganisms from the surplus sludge withstand the 20 to 30 days in the digester without detriment and their organic mass can therefore not contribute to methane gas production. The objective of most hydrolysis processes is therefore to damage the cell membranes in such a way that the microorganisms in the digester are able to utilize the constituents of the aerobic microorganisms and convert them to methane.

For this purpose, the organic substrates are treated in such a way that the included microorganisms are damaged such that the constituents are available for the methane-producing microorganisms present there in a subsequent anaerobic treatment stage. Mechanical methods among others, for example with ultrasound, are in widespread use for this purpose. In these methods, sufficient energy is introduced into the substrate or the sludge, with the aid of ultrasound generators among others, that the cell membranes are mechanically destroyed. The relatively high energy consumption and the short life of the ultrasound generators are a disadvantage. In purely thermal processes, a relatively high temperature level is sometimes required in order to achieve the required decomposition. Other methods have not become so established in the everyday use of sewage plants, due to the operating problems, among others, during sludge heating in high temperature ranges, for example greater than 100° C. One reason for this is that heating can no longer be carried out at the usually available temperatures, for example from the waste heat of a combined heat and power plant. In addition, steam, which is introduced into the substrate and in turn requires a continuous conditioning of feed water, is often used for heating. With wall heating at this temperature level, this can lead to significant encrustation.

When operating treatment plants, it has been shown that a direct heating of sometimes highly viscous substrates in a heat exchanger is very laborious due to the very poor heat transfer, as the flow can only be routed in a heavily turbulent manner. It is therefore of great advantage when substrates of this kind are mixed with already at least partially hydrolysed substrates. Although the temperature difference between substrate and heating medium is lower and therefore less favourable, this is far outweighed by the effect of the lower mixing viscosity, which means that the heat exchanger can be made significantly smaller. As a result of the circulation flow, the volume flow is in turn higher so that turbulent flow, in which the specific heat transfer is significantly better than in the laminar flow, can be achieved more easily.

Thus, there is a need for the present invention.

### SUMMARY OF THE INVENTION

The invention is based on the object of creating a method mentioned at the outset and an appropriate device with which problems of the prior art can be eliminated and, in particular, it is possible to create an improved method of hydrolysis of organic sludges with which the hydrolysis can be carried out more easily.

This object is achieved by a method with the characteristics of claim 1 and by a device with the characteristics of claim 10. Advantageous and preferred embodiments of the invention are subject matter of the further claims and are described in more detail below. In doing so, some of the characteristics are described only for the method or only for the device. Irrespective of this however, they should be applicable autonomously and independently of one another both to the method and to the device. The wording of the claims is made subject matter of the description by express reference.

For the purpose of hydrolysing liquid or fluid organic substrates, the substrate to be hydrolysed is introduced into a circulation loop for heating. In doing so, an equal amount of hydrolysed substrate is displaced from the circulation loop.

The method in accordance with the invention constitutes a simplification of the previous method technology for thermal-chemical hydrolysis mentioned above. Thanks to this simplification, the effect of the method may be slightly reduced; however this is in no proportion to the effort saved. In contrast with previous applications, the unpressurized reactor and an extraction pump can be dispensed with, as the substrate can be conveyed directly from the feeding pumps to the next process step.

Also, particularly with an existing building installation, it has been shown that it is often not so easy to integrate all components. Dispensing with the large-volume reactor in these applications is therefore of great advantage in enabling the system to be installed even under unfavourable structural conditions.

Advantageously, the supplied substrate is mixed with a chemical in order to change the pH value so that the effect of the hydrolysis is increased. Particularly advantageously, the supplied substrate can be mixed with caustic solution in order to raise the pH value and increase the effect of the hydrolysis. The caustic solution can be at least partially re-neutralized by means of the organic acids released in this process.

It has been shown that a combination of heat and the addition of caustic solution initiates a very intensive effect. As a result of the combination, the cells are damaged and the constituents are mostly released and the substrate is extensively hydrolysed. Surprisingly, this leads to the high pH value, which is for example produced by the addition of caustic soda solution, being completely neutralized by the organic acids which are then released. As a result, subsequent process steps, such as the anaerobic degradation of the constituents for example, are not adversely affected by an unfavourable pH value. Rather, the pH value can be adjusted by dosing the caustic solutions in wide ranges. Such devices and methods are basically disclosed in DE 10347476 A1 and DE 102014224663 A1.

Generally speaking, however, it is also possible and conceivable to carry out the hydrolysis described below without caustic solution. However, the effect is reduced as a result. Furthermore, the advantage that the released organic acids are neutralized by the caustic solution is also lost.

In an embodiment of the invention, a dwell time of the substrate in the circulation loop can be increased by an additional volume in the circulation or in the circulation loop. This additional volume can be between 10% and 100% of the existing volume of the circulation loop, advantageously between 20% and 50%.

Preferably, the volume flow of the circulation and the volume flow of the discharging substrate can leave the volume in the circulation or the circulation loop through different outlets. This results in a better separation and/or further processing.

In an embodiment of the invention, the additional volume can have internal fittings so that complete mixing does not occur. These can be flow-guiding means in the manner of vanes, deflectors or the like. At the same time, the discharging substrate can have a different dwell time compared with the circulation flow, for example increased by 5 to 120 minutes, preferably by 10 to 60 minutes.

Preferably, the dwell time of the discharging volume flow of the substrate is greater than that of the circulation flow, for example by up to a factor of 10 to 20.

In an embodiment of the invention, the substrate is fed into the circulation flow upstream of a heater, in particular also upstream of the circulation pump. Alternatively, a feeding-in of the substrate downstream of the circulation pump can be provided. In this way, the circulation pump is stressed to a lesser extent.

In order to carry out the method described above, a device or system for the hydrolysis of liquid, organic substrates can have a circulation loop, a feed device, a circulation pump for generating a circulation flow in the circulation loop, and a heater for heating and reheating the circulation flow. Advantageously, an additional volume can also be provided as mentioned above.

The heater can advantageously be designed as a heat exchanger for heating and reheating the circulation flow. External heat sources, such as the waste heat or long-distance heat of a combined heat and power plant, can therefore also be used.

An intermediate container can be provided in the circulation loop as the above-mentioned additional volume for increasing the dwell time of the substrate in the circulation flow or in the system.

In an embodiment of the invention, internal fittings are provided in the circulation loop, in particular in the above-mentioned additional volume. By this means, the ratio of the dwell times of circulating substrate to discharging substrate can be different, where advantageously the dwell time of the discharging substrate is greater than that of the circulating substrate, for example 10% to 200% greater.

These and other characteristics can be seen not only from the claims but also from the description and the drawings, where the individual characteristics can in each case be realized in isolation or jointly in the form of sub-combinations in an embodiment of the invention and in other fields, and may constitute advantageous as well as patentable embodiments in their own right, for which protection is claimed here. The subdivision of the application into individual sections and intermediate headings does not restrict the statements made thereunder in their general validity.

### BRIEF DESCRIPTION OF THE DRAWINGS

Further advantages and aspects of the invention can be seen from the claims and from the following description of preferred exemplary embodiments of the invention which are explained below with reference to the figures. In the drawings:

FIGS. 1 to 5 show exemplary methods for a treatment in accordance with the invention for hydrolysing organic substrates or in organic substrates.

### DETAILED DESCRIPTION OF THE PREFERRED EMBODIMENTS

While the invention will be described in connection with one or more preferred embodiments, it will be understood that it is not intended to limit the invention to those embodiments. On the contrary, it is intended to cover all alternatives, modifications and equivalents as may be included within the spirit and scope of the invention as defined by the appended claims.

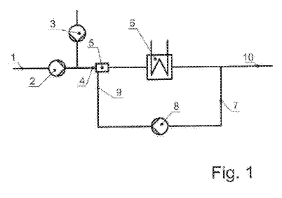

In the method according to FIG. 1, a liquid, organic substrate 1, for example the surplus sludge in a sewage plant, is fed to the system with the aid of a pump 2. If required, the organic substrate is mixed with caustic solution 3. The caustic solution is not absolutely essential but significantly increases the effect of the hydrolysis as explained previously. The substrate 4, which if required is mixed with caustic solution, is mixed 5 in a circulation loop consisting of heat exchanger 6, pump suction line 7, pump 8 and pump pressure line 9. The circulation flow 7 and 9 brought about by the pump 8 is preferably a multiple of the supplied substrate flow 1 so that, because of the lower mixing viscosity, better boundary conditions are created for the heat transfer in the heat exchanger 6 in spite of a poorer temperature gradient.

Preferably, the circulation flow is heated to a temperature of 30° C. to 180° C., in particular 40° C. to 90° C., preferably 60° C. to 70° C.

The ratio of the circulation flow to the feed flow can be 1:1 to 10:1, in particular 1:1 to 5:1, preferably 1:1 to 3:1.

As a result of the continuous feed of the substrate flow 1 to the circulation flow 6 and 8 a hydrolysed volume flow 10 equivalent to the supplied substrate flow 1 is always displaced from the system and fed to the next process step. In contrast to methods previously described, the reactor with its elaborate control system and flow guidance and a separate extraction pump can be dispensed with.

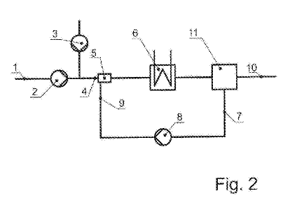

FIG. 2 shows similar system to that in FIG. 1 with an additional volume 11, as a result of which the dwell time of the substrate 1 in the system can be increased. The additional volume 11 is preferably to be arranged in the position where the discharging, hydrolysed substrate flow 10 is separated out of the system. Preferably, the dwell time of the supplied substrate is arithmetically increased by the additional volume 11 by 5 to 120 minutes, in particular 10 to 60 minutes, preferably 15 to 30 minutes.

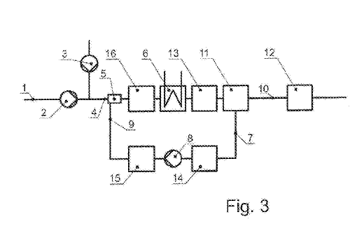

Some positions 12, 13, 14, 15 and 16, in which a volume for increasing the dwell time can likewise be realized, are shown by way of example in FIG. 3. However, if anything, this is for installation reasons.

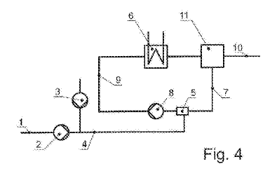

FIG. 4 shows a variant based on FIG. 2 in which the supplied substrate 1, if required mixed 4 with caustic solution 3, passes into the circulation loop on the suction side 7 of the circulation pump 8. As a result, an additional mixing of newly fed substrate 1 and circulation loop 7 and 9 or already circulating substrate takes place in the circulation pump 8. Advantageously, the pump 2, which is often present in any case, has practically the same operating data as before the additional installation of the hydrolysis, as virtually the same pressure conditions exist within the circulation loop at point 5 as at the outlet 10 from the circulation.

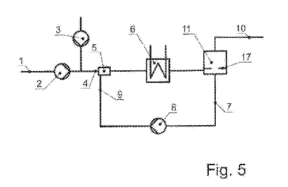

Based on FIG. 2, it is of advantage to design the volume 11 such that the dwell time of the already hydrolysed substrate flow 10 is greater than the dwell time of the circulation flow 7 and 9, see FIG. 5. This is achieved in that a partial separation 17 of the volumes occurs within the volume 11, which however the discharging volume flow 10 can negotiate. The separation 17 can be carried out by a baffle or a movable partition inside a stationary container.

Preferably, the ratio of the dwell time in the volume of circulation flow to discharging volume flow is 1:1 to 1:20, in particular 1:1 to 1:10, preferably 1:1 to 1:3.

Thus, it is apparent that there has been provided, in accordance with the invention, an invention that fully satisfies the objects, aims and advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. Method for a hydrolysis of liquid, organic substrates, wherein a substrate to be hydrolysed is introduced into a circulation loop for heating and wherein an equal amount of hydrolysed substrate is displaced from said circulation loop.

2. Method according to claim 1, wherein said introduced substrate is mixed with a chemical in order to change its pH value to increase an effect of said hydrolysis.

3. Method according to claim 2, wherein said introduced substrate is mixed with caustic solution in order to increase said pH value, to increase an effect of said hydrolysis, and to at least partially re-neutralize said caustic solution by means of organic acids released in said process.

4. Method according to claim 1, wherein a dwell time of said substrate in said circulation loop is increased by an additional volume in said circulation.

5. Method according to claim 4, wherein a volume flow of said circulation and a volume flow of a discharging substrate leave a volume in said circulation through different outlets.

6. Method according to claim 4, wherein said additional volume is formed by internal fittings so as to avoid a complete mixing, where said discharging substrate has a different dwell time compared with a circulation flow.

7. Method according to claim 6, wherein said dwell time of said discharging volume flow of said substrate is greater than said dwell time of said circulation flow.

8. Method according to claim 1, wherein said substrate is fed into a circulation flow upstream of a heater.

9. Method according to claim 8, wherein said substrate is fed into said circulation flow upstream of a circulation pump.

10. Device for the hydrolysis of liquid, organic substrates for carrying out the method according to claim 1, having:
a circulation loop,
a feed device,
a circulation pump for generating a circulation flow in said circulation loop,
a heater for heating and reheating said circulation flow.

11. Device according to claim 10, wherein said heater is designed as a heat exchanger for heating and reheating said circulation flow.

12. Device according to claim 10, wherein an intermediate container is provided in said circulation loop as an additional volume for increasing a dwell time of said substrate in said device.

13. Device according to claim 10, wherein a feeding of said substrate into said circulation flow upstream of said heater is provided.

14. Device according to claim 13, wherein a feeding of said substrate into said circulation flow is provided downstream of the circulation pump.

15. Device according to claim 10, wherein a feeding-in of said substrate is provided on a suction side of said circulation pump.

16. Device according to claim 10, wherein internal fittings are provided in said circulation loop, so that a ratio of dwell times of said circulating substrate to discharging substrate is different.

17. Device according to claim 16, wherein internal fittings are provided in said circulation loop in said additional volume according to claim 12.

18. Device according to claim 16, wherein said dwell time of said discharging substrate is greater than said dwell time of said circulating substrate.
